(19) United States
(12) Patent Application Publication
(10) Pub. No.: US 2026/0089011 A1
(43) Pub. Date: Mar. 26, 2026

(54) METHOD FOR CONSTRUCTING A DECENTRALIZED DATA COMMUNICATION STRUCTURE WITHIN A SYSTEM HAVING A PLURALITY OF COMPONENTS

(71) Applicant: SMA Solar Technology AG, Niestetal (DE)

(72) Inventors: Ingo Hanke, Göttingen (DE); Jörn Tümmler, Habichtswald (DE); Mirko Wischer, Bad Hersfeld (DE); Tobias Graf, Vellmar (DE)

(21) Appl. No.: 19/410,340

(22) Filed: Dec. 5, 2025

Related U.S. Application Data
(63) Continuation of application No. PCT/EP2024/064753, filed on May 29, 2024.

(30) Foreign Application Priority Data
Jun. 7, 2023 (DE) 10 2023 115 048.0

(51) Int. Cl. H04L 9/32; H04L 9/08

(52) U.S. Cl. CPC H04L 9/3247; H04L 9/0825; H04L 9/3263

(57) ABSTRACT

A method for constructing a decentralized data communication structure within a system having a plurality of components, wherein each component contains a private key, an associated public key, a secret secured against read-out, and certificate information that is unsigned in the initial state and contains the public key, includes establishing a registering component of the plurality of components, wherein the establishment includes storing a list of validation entries, constructing a tamper-proof channel between the registering component and a first component of the other components, and authenticating the first component at the registering component and authentificating the first component using the list of validation entries via the tamper-proof channel. The authentication comprises signing the unsigned certificate information of the first component by the registering component via the tamper-proof channel. A system such as an energy generation plant having a plurality of components is configured to carry out the method.

### REFERENCE TO RELATED APPLICATIONS

This application is a Continuation of International Application number PCT/EP2024/064753, filed on May 29, 2024, which claims the benefit of German Application number 10 2023 115 048.0, filed on Jun. 7, 2023. The contents of the above-referenced Patent Applications are hereby incorporated by reference in their entirety.

### FIELD

The disclosure relates to a method for constructing a decentralized data communication structure within a system having a plurality of components, and to a system having a plurality of components which is configured to carry out the method.

### BACKGROUND

High security requirements must be met in order to protect critical infrastructure, for example, systems for generating and feeding energy into a public grid, from cyberattacks. It is therefore required that the connection of such systems to a data network be reduced to the functionally necessary level or dispensed with altogether. Nevertheless, the components of such a system must be able to communicate with one another in a tamper-proof and tap-proof manner, even if a cyberattack may only be possible via direct access to one of the components or to the communication link between components, which can only be carried out on site. For this purpose, methods have been developed that are based on the existence of already signed certificates on the components of the system. However, the installation of a system that provides the prerequisites for carrying out such methods is complex, as it requires the distribution of such certificates to each of the components in a secure manner, for example, as early as during the production of the component, otherwise by a direct data connection to each of the components of the already installed system. For example, the use of components from multiple manufacturers in one system is made more difficult due to the lack of existing standards.

Document US 2021/0184864 A1 discloses a method for constructing a certificate infrastructure in a system with mixed signature protocols. Different digital certificates are generated for the different protocols. Furthermore, document WO 2013/123548 A2 also shows a method for providing keys for secure communication between two users in a decentralized network or an application for sharing information between users via a shared data memory.

Other methods rely on the components signing their certificates themselves. Such methods are easy to implement, but have the major disadvantage that a secure verification of the identity of such a device by other communication partners is not possible. Although communication between two devices can be encrypted in this way, correct mutual authentification of the communication participants cannot be achieved. This makes it possible for an unauthorized third party (“man-in-the-middle”) to interrupt and intercept the communication between two devices.

### SUMMARY

Accordingly, the present disclosure is directed to a method for constructing a decentralized data communication structure within a system having a plurality of components, which method can be implemented securely and with little effort, and which allows the use of efficient and proven standard communication protocols within the decentralized data communication structure.

In the context of this description, the term “authenticate” shall mean that a communication participant identifies itself and requests confirmation of recognition of its identity at another communication participant. The term “authentificate” shall mean the act of verifying the identity of the requesting participant and communicating the result of the verification by the participant receiving the authentication request. In case of a successful verification, a signed certificate may be issued to the requesting party, for example. Accordingly, authentification is performed in response to an authentication.

In a system having a plurality of components, wherein each component of the system has a private key, an associated public key, a secret secured against read-out, and certificate information that is unsigned in the initial state and contains the public key, a method according to the disclosure for constructing a decentralized data communication structure within the system comprises establishing a registering component of the plurality of components, constructing a tamper-proof channel between the registering component and a first component of the other components, authenticating the first component at the registering component and authentificating the first component using the list of entries via the tamper-proof channel. The authentification comprises, in one embodiment, signing the unsigned certificate information of the first component by the registering component via the tamper-proof channel. In one embodiment, the establishment comprises storing a list of validation entries.

In the context of the present disclosure, the term validation entry is understood to mean an entry that was generated from the respective device-specific secrets of the plurality of components and allows checking the knowledge of the device-specific secrets without transmission thereof. The validation entry can contain the secret itself or consist thereof, but it is advantageous, in one embodiment, if the validation entry only contains a data set calculated using the secret, from which the secret itself cannot be calculated. The validation entry can contain, for example, a salted hash value of the secret. However, the validation entry can also contain a nonce or a plurality of nonces (randomly generated data sets) and, for each nonce, an associated hash value as the expected response, which was determined from a combination of the nonce and the secret. In case of a plurality of nonces, to increase cybersecurity, it can be provided for each nonce to be used only once or to be used again only after the other nonces have been used.

In one embodiment, signing can comprise transmitting the public key of the registering component via the tamper-proof channel. If the public key is transmitted only in the context of signing, the security of the data communication structure against cyberattacks can be increased because the public key is transmitted only to authentificated components.

Establishing a registering component of the plurality of components can, for example, be carried out by an installer as an authorized party via an encrypted and tamper-proof data connection. The validation entries can be generated by the installer entering serial numbers of the components to be included in the decentralized data communication structure into a terminal device, and the terminal device then identifying and transmitting the validation entries to be transmitted to the registering component. Identification can take place via a database stored locally on the terminal device or by retrieving the validation entries for the serial numbers from a remotely stored database. The further components of the system do not need to be in operation or accessible via a data connection at such time.

Constructing a tamper-proof channel between the registering component and a first component of the system can be done using a pre-shared key. For this, it is conceivable for the authorized party to connect to the first component via an encrypted and tamper-proof data connection and transmit the pre-shared key, for example, the public key of the registering component, in this way. It is also conceivable for the pre-shared key to be stored as early as during production together with the device-specific secret in a memory area that is specifically secured against read-out. In addition to protection against tampering of the transmitted data, the channel can also be encrypted and/or secured against unauthorized retransmission (so-called replay attacks).

Authentification of a component in response to the authentication can be done via the tamper-proof channel by the first component transmitting the unsigned certificate information to the registering component. Authentification further includes checking whether a secret corresponding to the validation entry contained in the list for the component is stored on the first component. During this check, the secret should remain on the first component and should not be transmitted. This can be done, for example, by the registering component transmitting a first data set in the form of a nonce stored in the validation entry to the first component, the latter calculating a hash value of a combination of the first data set and the stored secret and transmitting same as a second data set back to the registering component. In one embodiment, the signing and retransmission of the signed certificate information is carried out only if the second data set is identical to an expected response of the validation entry associated with the first data set. Signing can be done by encrypting the unsigned certificate information, a part thereof or a data set calculated therefrom, for example, a hash value, with the private key of the registering component. Each component can then verify the trustworthiness of the signed certificate information using the public key of the registering component. During signing, further information can also be added to the certificate information by the registering component. In one embodiment, a validity period or further validity criteria can be added that must be met in order for the signed certificate to be classified as trustworthy.

The unsigned certificate information can also contain further constituent parts in addition to the public key of the associated component, for example, information for establishing a data connection to the associated component such as a domain name or an IP address.

Authentification can be performed for each component of the system to obtain certificate information signed by the registering component; after authentification is performed, the component can use the signed certificate information to prove its trustworthiness to other components of the system. Using known protocols, a session key can then be agreed upon with the other components, which provide certificate information signed by the registering component, to construct a secure communication channel. The communication channel can be secured, for example, by symmetric encryption via the session key. The protocol used can be a TLS protocol. This allows high data transmission rates to be achieved with little effort.

Proof of the trustworthiness of signed certificate information can be provided in a known way via the public key of the registering component. This can be queried at any time from the registering component and can also be transmitted via an unsecured communication channel without compromising the integrity of the communication structure.

In a further aspect of the disclosure, a system having a plurality of components with the features described above is configured to carry out the method according to the disclosure. Advantageously, one component of the plurality of components has an interface for logging in a system user, wherein the interface is configured to establish the one component as a registering component and to store the list of validation entries of the other components of the system. The interface can, in one embodiment, be an interface for wired communication, for example a LAN interface, to which a terminal device of the system user can be connected. In one embodiment, the system has a generator, a consumer, a converter or a storage device for electrical energy. In one embodiment, the system is configured to exchange electrical power with an energy transmission network.

In one embodiment, the system does not have a data connection to an entity outside the system, for example, no Internet connection. This renders external data access to the system, in particular a cyberattack, impossible. Alternatively, only one of the components is equipped with such a data connection. Such component can be specifically secured against cyberattacks and, for example, can be accessible only from selected entities or via a specifically secured connection.

### BRIEF DESCRIPTION OF THE FIGURES

The disclosure is illustrated below with reference to the figures, in which:

FIG. 1 shows a data structure of a component of a system according to the disclosure;

FIG. 2 shows a flowchart of a method according to the disclosure;

FIG. 3 shows a partial step of the flowchart of FIG. 2; and

FIG. 4 shows a system according to the disclosure after the method according to the disclosure has been carried out.

### DETAILED DESCRIPTION

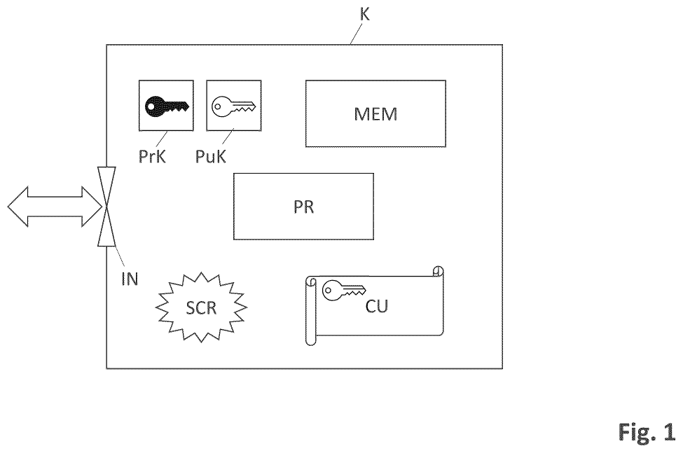

FIG. 1 shows a data structure of a component K of a system that is configured to construct a decentralized data communication structure. The component K has an interface IN for data communication with other components. The component K further comprises a processor PR (e.g., circuitry) and a memory MEM, which provides essential functions of the component. In addition to a key pair composed of a private key PrK and an associated public key PuK for encrypting and decrypting data, the component K contains a secret SCR in a memory area secured against external read-out. The private key PrK can also be stored in the memory area secured against external read-out. For example, the key pair can be generated and stored during production of the component, or the component can generate the key pair using randomly generated data during commissioning or based on a command received via the interface IN. The secret is, in one embodiment, generated during production of the component and a copy of the secret is stored in a database at the component's producer. Alternatively, in another embodiment, the secret can be determined from the component's serial number, or can be legibly affixed to the component, or can be included in the documentation supplied with the component. In one embodiment, the system comprises a system for generating, using and/or converting electric energy, and the components of such systems may be PV plants, converters, statcoms, storage units, electrolyzers, fuel cells, etc. and all such variations, combinations and permutations are contemplated as falling within the scope of the present disclosure.

In addition, the component K includes an initially unsigned certificate CU, which contains a copy of the public key PuK of the component K, which is to be indicated by the key symbol in the certificate CU. The certificate CU can contain further information, for example, an address under which the component K can be addressed via the interface IN. A system is formed by a plurality of components K with such a structure, between which a decentralized data communication structure is to be constructed that is secured against external access or tampering. The system can be an energy generation plant connected to a supply grid.

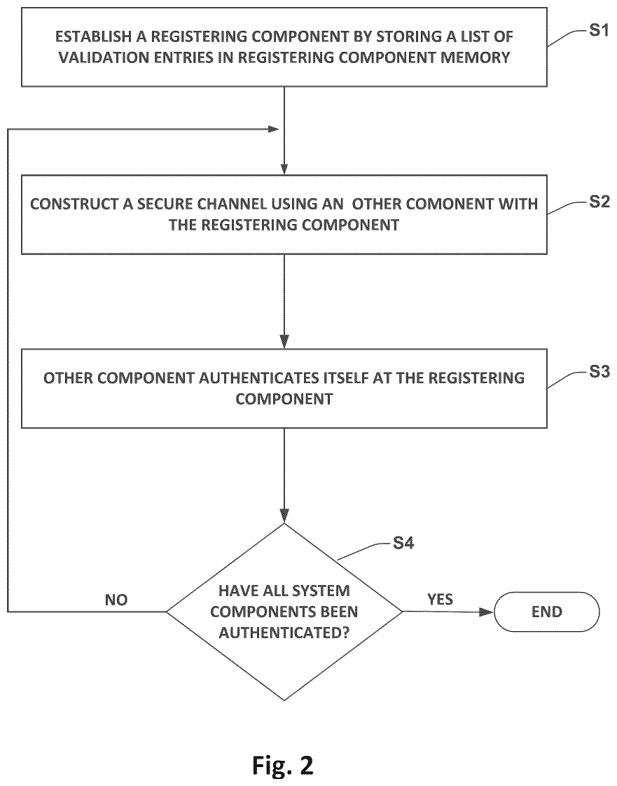

In a method shown in FIG. 2 for constructing a decentralized data communication structure within a system having a plurality of components, a first act S1 comprises establishing a registering component of the plurality of components. In principle, any of the components of the system can be selected as a registering component. The establishment can be carried out by an installer as part of commissioning the system. In one embodiment, the establishment comprises storing a list of validation entries in the memory of the registering component that determines which authentications of other components of the system are accepted by the registering component. The list of validation entries can be generated from a list of device-specific secrets, wherein the device secrets can be enclosed with the device in printed form or printed on the nameplate. To generate the validation entries, it may be necessary, in one embodiment, to query the secret associated with the respective device in the producer's database. The selection of a component as a registering component can be stored in the memory of the registering component.

In a second act S2, another component can then construct a channel secured against tampering with the registering component. Such construction can be achieved using known methods such as the Diffie-Hellman method. This does not yet require proof of trustworthiness between the communication partners.

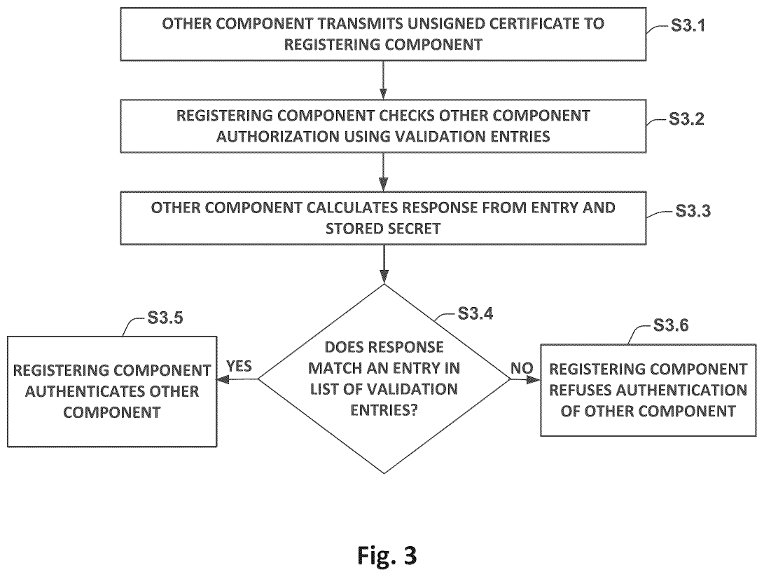

In a third act, the other component authenticates itself at the registering component. This is broken down in more detail in FIG. 3. For this purpose, the other component transmits its initially unsigned certificate to the registering component in a first partial act S3.1. The registering component checks the authorization of the other component by means of the validation entries. For example, the check in a second partial act S3.2 can comprise sending an entry from the validation entries from the registering component to the other component, which calculates a response from the entry and the secret stored with the other component and sends it back to the registering component in a third partial act S3.3. If the response in a fourth partial act S3.4 matches an entry in the list of validation entries associated with the expected response, the registering component authentificates the other component in a fifth partial act S3.5; otherwise, it refuses the authentification in a sixth partial act S3.6. Authentification comprises, in one embodiment, signing the unsigned certificate information of the other component by means of the private key of the registering component and returning the signed certificate via the secure channel. In one embodiment, the public key of the registering component is also sent when the signed certificate is returned, which allows for subsequent verification of the trustworthiness of the certificate. Alternatively, the public key can also be transmitted at another point in time, for example, after mutual authentification of both communication partners. This ensures that the public key of the registering component actually originates from the registering component.

In this way, each of the other components can then authentificate itself at the registering component one after the other and thus receive a certificate signed by the registering component. Therefore, the method can be terminated if it is determined in a fourth act S4 in FIG. 2 that all components of the system have been successfully authentificated. This ensures that subsequently each component of the system has a certificate signed by the registering component and has the public key of the registering component and can use this information to agree on a session key with each other component of the system using known protocols, such as the transport layer security (TLS) protocol, and thus establish a secure and trustworthy data connection. It is also impossible for external components to establish such a connection with components of the system or to intervene in them unnoticed, since a foreign component cannot achieve authentification by the registering component because it does not have a secret that matches the list of validation entries. The decentralized data communication structure constructed using the method according to the disclosure is therefore a closed structure.

If necessary, the method can be repeated at any time to rule out any suspected compromise. All that is required is for the registering component to generate a new key pair, i.e., a new private and public key, and replace the old public key in the system with the newly generated public key. The other components can then recognize that re-authentication of their certificates is required and can initiate this with the registering component.

It is also easy to add further components to the system at a later point in time by adding a validation entry for the new component to the list of validation entries. The further component can thus also successfully authenticate itself at the registering component.

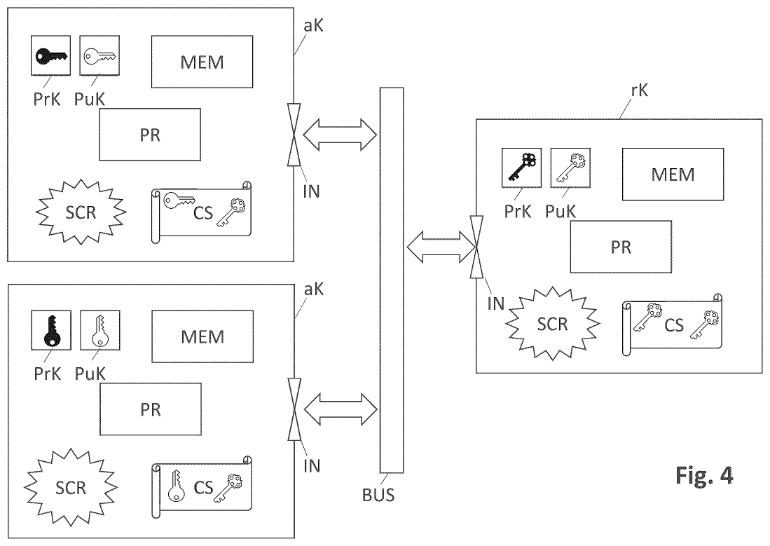

FIG. 4 shows a system after the method according to the disclosure has been carried out. Both a registering component rK and a number of other components aK are configured to communicate with one another via a bus BUS and are also connected to the bus via an interface IN. This interface can be a wired or wireless connection, such as a radio connection. After the method according to the disclosure has been carried out, each component has a certificate CS signed by the registering component rK. This is indicated by the symbol of the public key of the registering component rK in the signed certificate CS. The registering component rK has a self-signed certificate CS. The other constituent parts of the components of the system, such as the processor circuit PR, the memory MEM, the component's own key pair PrK, PuK, and the secret SCR correspond to the same-name constituent parts of FIG. 1.

By providing a first component's own certificate to a second, other component of the system as the desired communication partner, the second component can receive the public key of the first component and check its trustworthiness by means of known methods, and it can send back its own signed certificate as a response for establishing contact. The latter can check the trustworthiness of the first component in the same way. After successful mutual assurance of trustworthiness, a temporary key for secure communication can easily be agreed upon using the public keys. The communication method can, for example, be the TLS method or a secure socket layer (SSL) method, which allows for high data rates and low computing effort for the processors PR of the communication partners involved while maintaining a high level of cybersecurity.

What is claimed is:

1. A method for constructing a decentralized data communication structure within a system having a plurality of components, wherein each component contains a private key, an associated public key, a secret secured against read-out, and certificate information that is unsigned in an initial state and contains the public key, comprising:
establishing a registering component from one of the plurality of components, wherein the establishing comprises storing a list of validation entries in a memory of the registering component,
constructing a first tamper-proof channel between the registering component and a first component of the other components of the plurality of components, and
authenticating the first component at the registering component (rK) and authentificating the first component (K1) using the list of validation entries via the first tamper-proof channel,
wherein authentificating comprises signing the unsigned certificate information of the first component by the registering component via the first tamper-proof channel.

2. The method according to claim 1, wherein signing further comprises transmitting the public key of the registering component via the first tamper-proof channel.

3. The method according to claim 1, further comprising:
constructing a second tamper-proof channel between the registering component and a second component of the other components of the plurality of components, and
authenticating the second component at the registering component (rK) and authentificating the second component (K2) using the list of validation entries via the second tamper-proof channel,
wherein authentificating comprises signing the unsigned certificate information of the second component by the registering component via the second tamper-proof channel.

4. The method according to claim 3, further comprising constructing a secure communication channel between the first component and the second component by exchanging the signed certificate information of the first component and the second component and transmitting a session key for the constructed secure communication channel that is encrypted using one piece of the signed certificate information, wherein the one piece of the signed certificate information comprises a portion from the first component, the second component, or both the first component and the second component.

5. The method according to claim 4, wherein the secure communication channel between the first component and the second component has a symmetric encryption via the transmitted session key.

6. The method according to claim 4, wherein the secure communication channel uses a transport layer security (TLS) protocol.

7. The method according to claim 4, wherein constructing the secure communication channel comprises querying the registering component for its public key and checking the signed certificate information using the public key.

8. The method according to claim 1, wherein signing the unsigned certificate information comprises signing with a time-limited validity.

9. A system having a plurality of components, wherein one of the plurality of components is a registering component, and each component comprises a private key, an associated public key, a secret secured against read-out, and certificate information that is unsigned in an initial state and contains the public key, wherein the system is configured to:
establish a registering component from one of the plurality of components, by storing a list of validation entries in a memory of the registering component,
construct a first tamper-proof channel between the registering component and a first component of the other components of the plurality of components, and
authenticate the first component at the registering component and authentificate the first component (K1) using the list of validation entries via the first tamper-proof channel,
wherein in the authentification the registering component is configured to sign the unsigned certificate information of the first component via the first tamper-proof channel.

10. The system according to claim 9, wherein one component of the plurality of components has an interface for logging in a system user, wherein the interface is configured to establish the one component as the registering component and to store the list of validation entries.

11. The system according to claim 9, wherein one of the components has a generator, a consumer, a converter or a storage device for electrical energy.

12. The system according to claim 9, wherein the system has no data connection to an entity outside the system.

13. The system according to claim 9, wherein exactly one of the components has a data connection to an entity outside the system.
